(19) United States
(12) Patent Application Publication
(10) Pub. No.: US 2007/0027827 A1
(43) Pub. Date: Feb. 1, 2007

(54) Self regulating system for human resources management

(76) Inventor: Yurij Karpovich Balagaev, Respublika (RU)

Correspondence Address: LADAS & PARRY, 26 WEST 61ST STREET, NEW YORK, NY, 10023, US

(21) Appl. No.: 10/526,883

(22) PCT Filed: Jan. 30, 2003
(86) PCT No.: PCT/RU03/00030

§ 371 Date: Oct. 12, 2005

(30) Foreign Application Priority Data
Sep. 3, 2002 (RU) 2002/123108

(51) Int. Cl. G06N 5/00

(52) U.S. Cl. 706/45

(57) ABSTRACT

The invention relates to intellectual self-regulating systems and can be used for a human resources management. The inventive system comprises active constructive elements in the form of self improving systems i.e. staff members, specialised records, specialised computer for forming managerial decisions, computer or specialised data input/output devices. Said invention makes it possible to improve the efficiency of the human resource management by forming motivators of working efficiency in a group of staff members which are united by common professional goals.

The invention is belongs to automated systems for personnel management.

Today's technology offers quite a few methods and systems for personnel management.

There is a well-known computer-aided system for production and projection management [Application PCT WO 97/07472, MPK G 06 F 17/60]. It comprises a platform of the working environment with role modules positioned according to the workplace allocation. During the work users create an object of the working process and write it to memory of the computer-aided system of production ad projection management. All data pertaining to the administration of production and projection is reported to this object of the working process and use it as the database.

Another known system of dynamic business process management [Patent WO0199011, G06F17/60, G06N5/00]. The system features a database where it stores all information about business processes, and an attached input/output device. The system collects data about one or multiple business processes, determines the goals and models possible trajectory of their achievement.

There is also another system for analysis, planning, and calculating the sequence of actions in management tasks [U.S. Pat. No. 6,282,531, G06F 017/60]. The system encompasses special tools for interactive input of working data, as well as output of the processed results to the user. The system employs algorithms for risk assessment and decision making.

A system for business process management [Application PCT WO 94/18620 MPK G 06 F 7/06]. The system for business-thread management fulfills eight major tasks: registers users, equips users with all necessary tools for task processing, supplies users with appropriate information pertaining to their tasks, enables them to see acceptable deviations from their task with regard to the general process, manages requirements, warnings, and further actions ensuring process dynamics; automates central standard procedures, integrates existing organized business systems, provides users with an easy-to-use interface to replicate for new users participating in the working process:

There's a self-regulating system for assessment and correction of behavioural aspects of human activities. [U.S. Pat. No. 6,341,267, G06F 017/60]. The system determines the type of a person's behaviour and suggests ways to develop and train particular abilities. Thus, it gives and opportunity to influence human behaviour in using automated system. This was written down as the technical result.

A prototype of a self regulating system for personnel management can be found in a information analytical system for modeling of a rational business system of a company [Patent RU2171498, MPK G06N1/00, G06F17/00]. The system is capable of modeling components of a business system and their relations, connection to external data sources, implementation in at least one computing device connected to at least one operator workplace, equipped with at least one interface. This system features a set of instruments for modeling business systems using the modern information technology in management and unified methodology springing from the interfunctional nature of business development, considering most factors that affect business process, and integrating various aspects of company's activities. Therefore, it increases company's productivity and coordination of executing decision making on all level of the business system.

The downside of the prototype is seen in that the targeted increased effectiveness in a company is conceived through optimization of business system at predetermined external factors and without much attention to the effect of the social factor in side the company. Besides, the above mentioned system works only for certain business processes and is not capable of adequate response to all possible changes in a company.

The suggested invention provides a solution for increased efficiency in personnel management by introducing motivators for effective work within a group of colleagues bound by common work tasks (a social group). The system's performance does not depend on the actual technical tasks and sphere of application. It is not susceptible to changeable external factors and delivers expected result in highly indefinite conditions, discloses internal problems in the group of company employees united by common goals, creates motivators and uses them in the feedback chains between the system's computing device (decision generator) and individual employees to achieve these goals. All that while the system (the set of goals and degree of influence on decision making) is monitored by company staff and the administrator of the self-regulating systems. This expands its capabilities and application opportunities.

The technical result is achieved through self-regulation in the system of personnel management while configuring the system (self-configuring) and in solution generating. The self-regulating system for personnel management comprises active human elements—the employees of the governed work process, also a system of links represented by registries (including feedback registries), a computing device, and special input/output devices. Use of a human person as an active element of a self-regulating social system is determined by their being an objectively existing self-advancing system, closely studied and described by science on physiological, psychological, social and other levels. Their functional parts, organs and self-regulating contours served as prototypes for technical innovation and solution.

The invention is illustrated by diagrams:

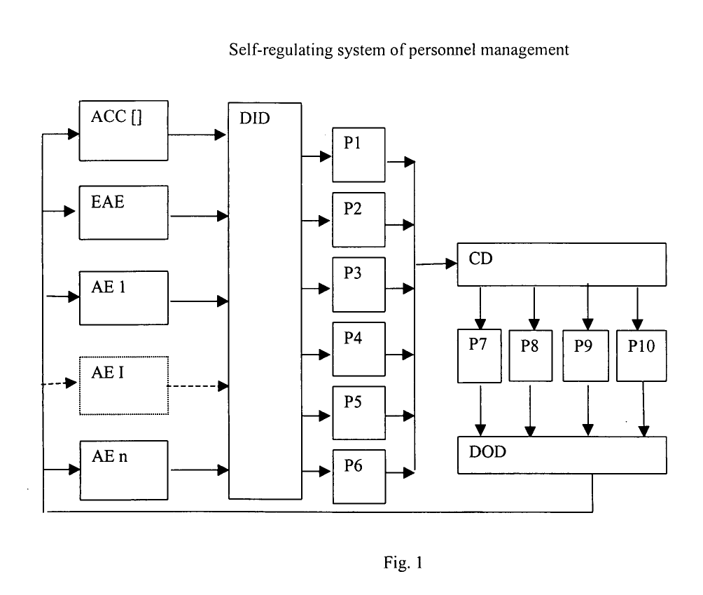

FIG. 1. Functional schema of a personnel management self-regulating system.

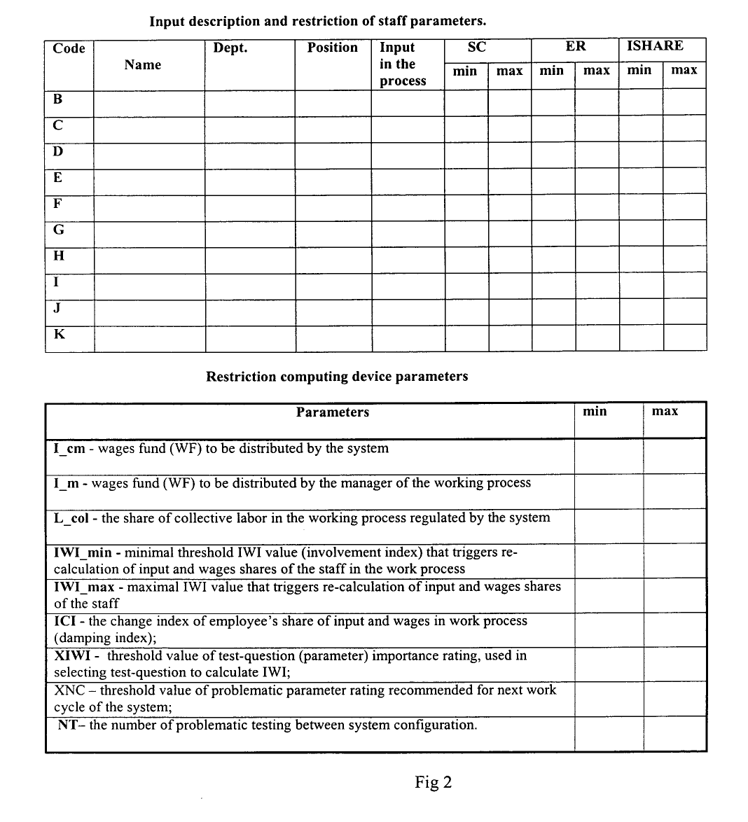

FIG. 2. P1—registry of the source data: financial settings and parameter delimiters. A register is a form of command of the work process manager (aka—self-regulating system administrator) to distribute the input of the employees in the working process and to delimit unified parameters of the employees and those of the computing device—solution generator.

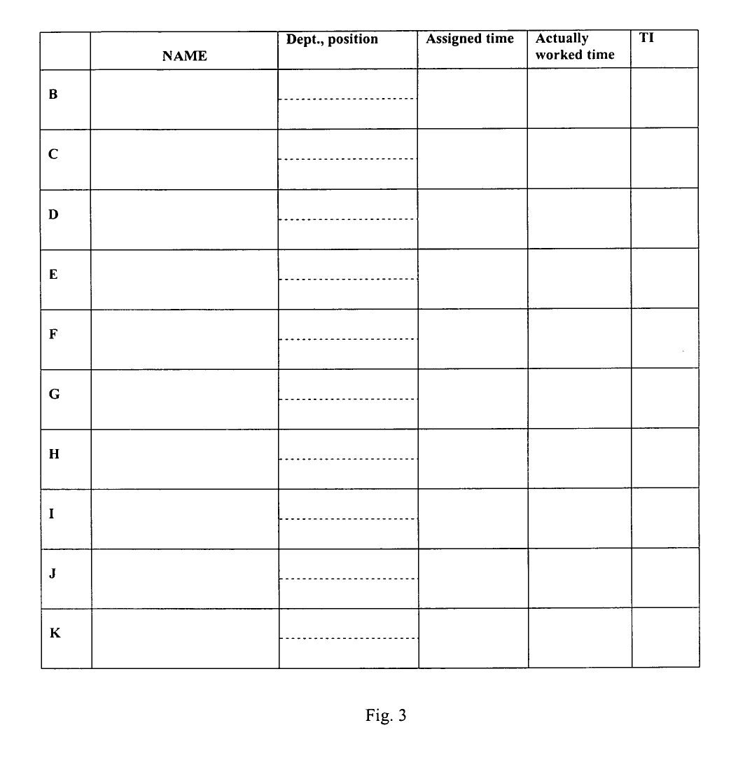

FIG. 3. P2—registry of the personnel time-sheet index. Time-sheet index shows percentage of the actually worked time by an employee in relation to assigned time for the test period.

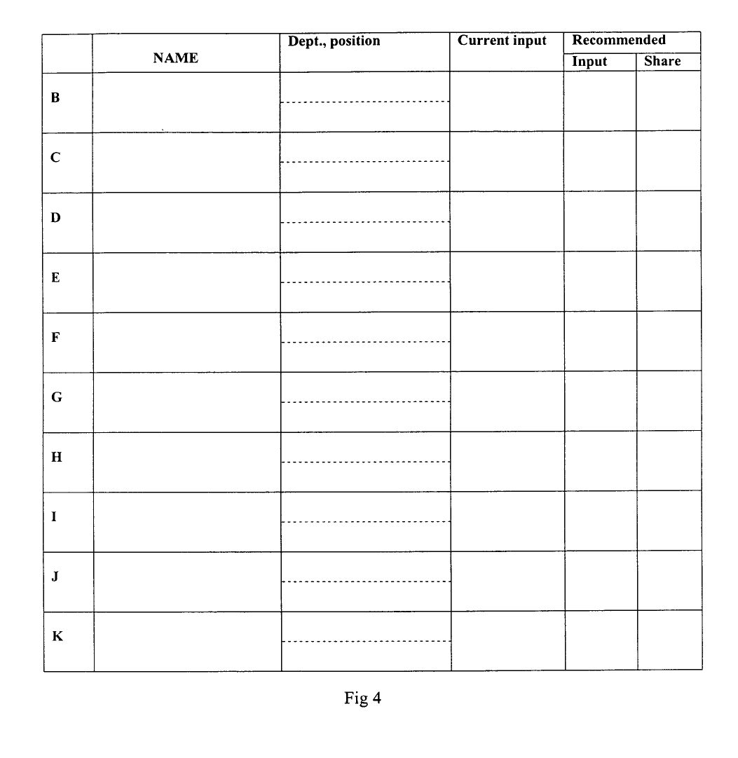

FIG. 4. P3—registry of the active elements—employees.

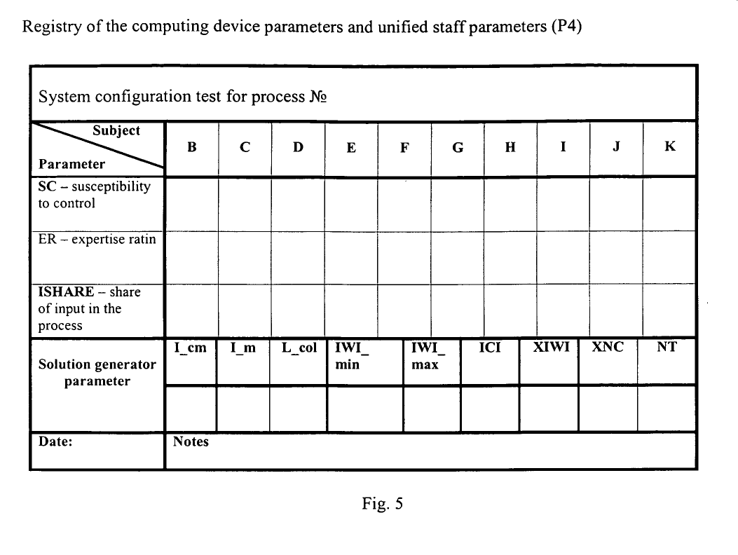

FIG. 5. P4—registry of the system parameters ratings. It is implemented as a test-card, and is designated to represent the ratings of the unified parameters of active elements and those of the computing device—the solution generator.

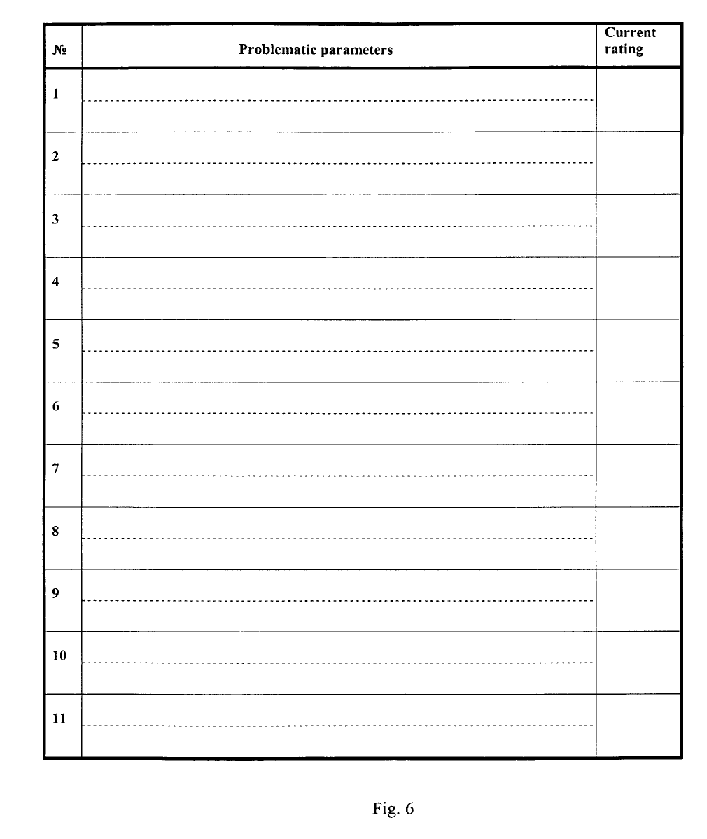

FIG. 6. P5, P10—registries of the problematic parameters descriptions. Here, P5 is the registry of problematic parameters received from active elements and the administrator; and P10 is the registry of problematic parameters advised by the system.

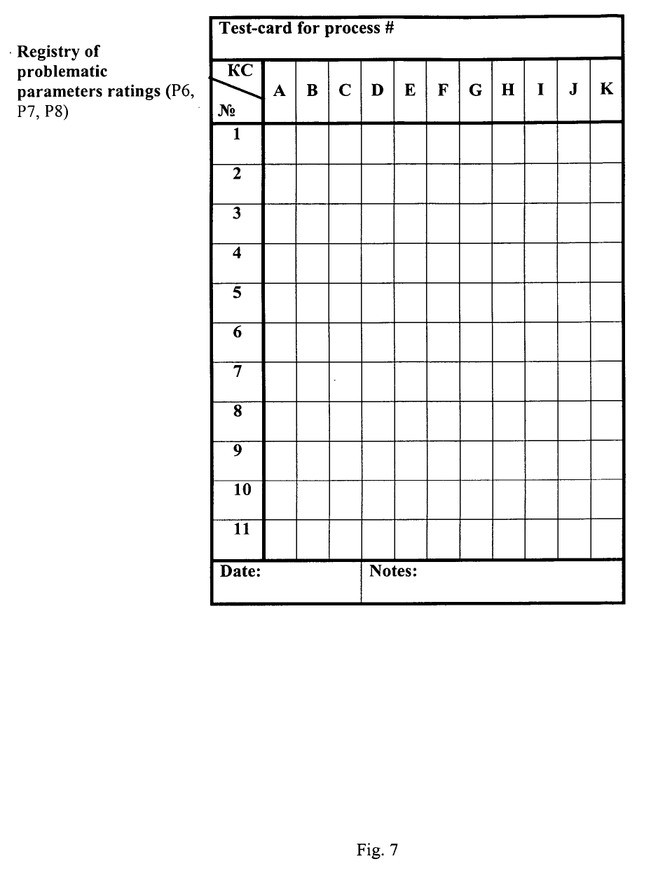

FIG. 7. P6, P7, P8 are registries of problematic parameters ratings. They are implemented as test-cards with cells for rating the gravity of the problematic parameters (first column), as well as for rating each employee's input, —their names taken from registry P3—in each problematic parameters from registry P5. Registry P7 is for rating employees' input in problematic parameters by executive active element. Registry P8 is for rating employees' input in problematic parameters by a group of active elements. These ratings are calculated by a special calculating procedure on the basis of the employees' subjective ratings.

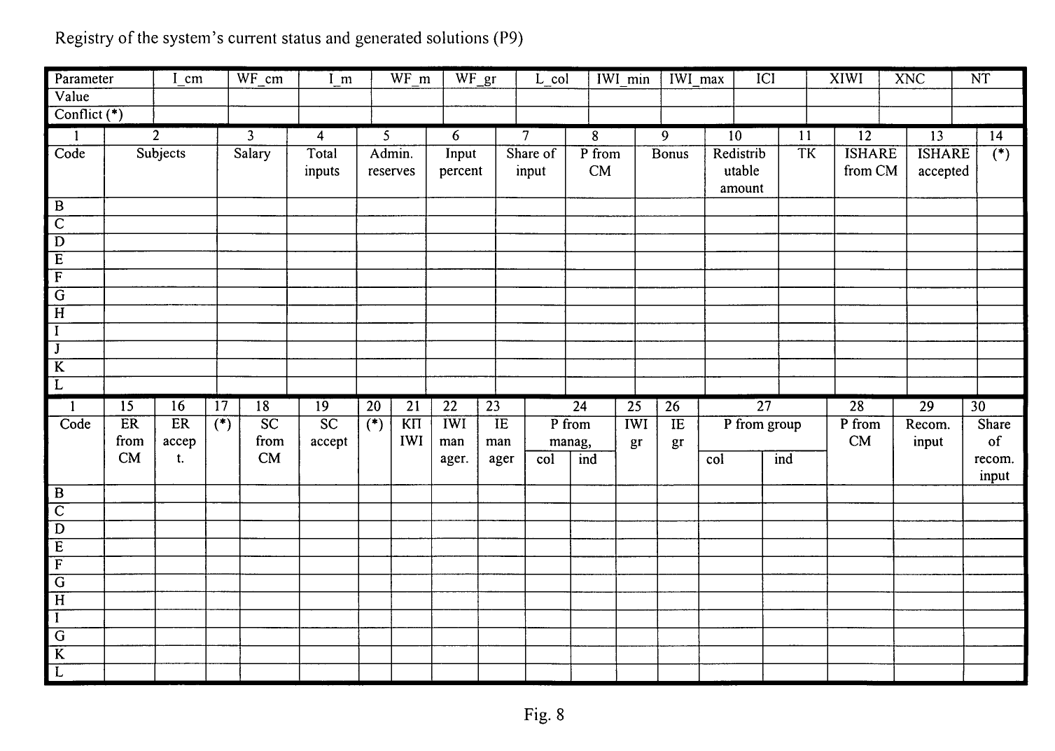

FIG. 8. P9 is a registry of the present status of the self-regulating system and generated solutions.

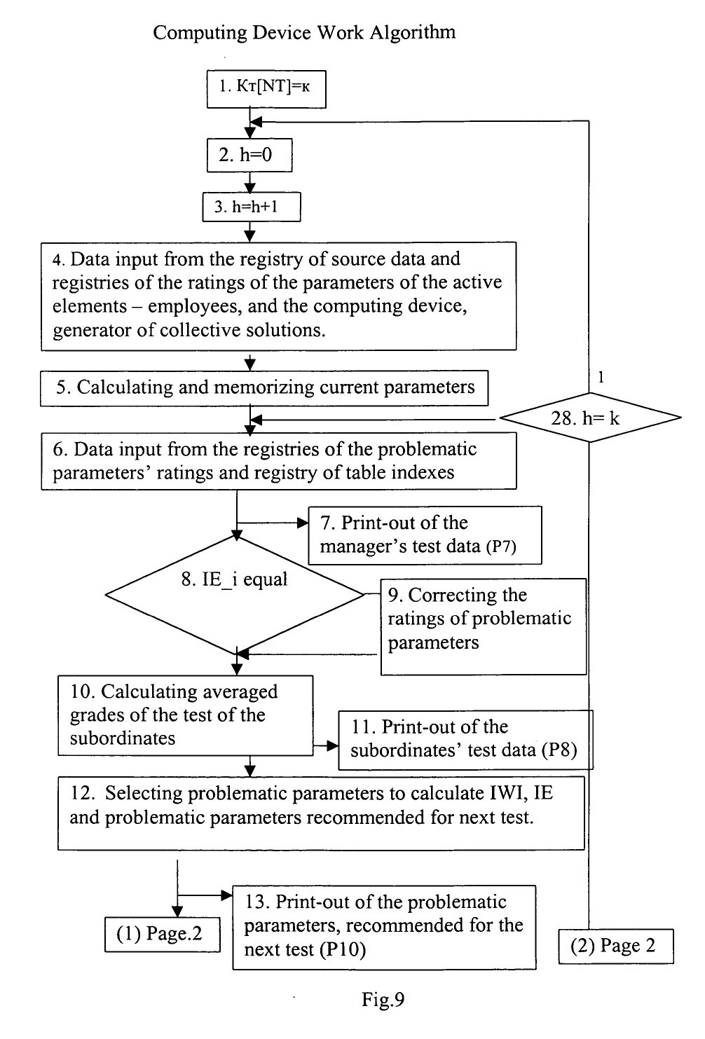

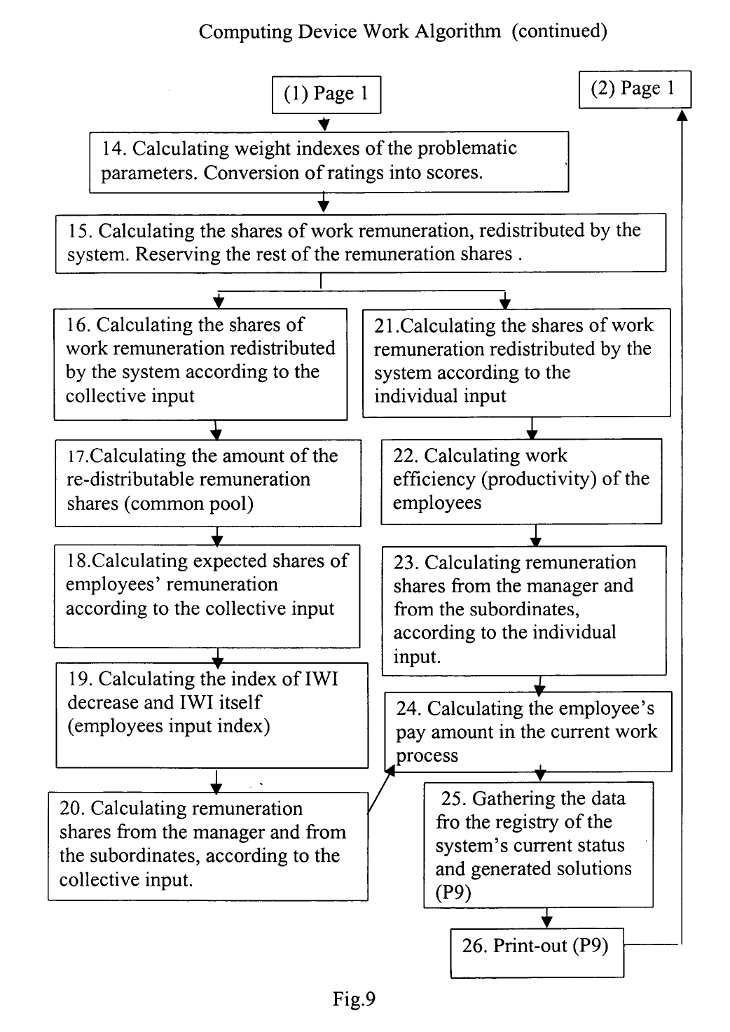

FIG. 9. Computing device work algorithm.

Self-regulating system of personnel management (Diagram 1) consists of incoming data registries P1, P2, P3, P4, P5, P6, feedback registries P7, P8, P9, P10, computing device CD, data input device DID (a keyboard, etc.), data output device DOD (a printer, display, etc.). The system incorporates employees AE1 . . . AEi as active elements of the self-regulating system, and an executive active element EAE. The system also includes an administrator of self-regulating systems, which supplies source data and applies limits on parameters of the system in question and other similar systems.

Computing device is intended to process data by using a path of system setup algorithm (that configures and corrects parameters) and a path of algorithm that generates solutions on discovered problematic parameters and subsequently outputs the solution and information on the system's current status into P7-P10 registries.

The computing device is used to generate solutions to configure the system and to create motivators for effective staff performance. It is represented by an interface furnished with computing device controls, by registers that are structurally identical to the registries of the self-regulating system, and by an algorithm (FIG. 9) that comprises a contour for system configuration (contour of parameter setup and correction) and a contour for problematic data processing (solution generating contour).

The system has three groups of parameters:

unified parameters of the system active elements—staff;

computing device parameters (solutions generator);

system's problematic parameters that are being formed or corrected anew as test-questions, each working cycle of the system.

To effectively track a member of staff in the self-regulating system, the following parameters are used:

1. SC—employee's susceptibility to control;

2. ER—expertise rating of the employee;

3. ISHARE—employee's share of input and income in the work process.

The specified parameters quite adequately reflect relationships in any social group of cooperating and at the same time competing subjects. Properly formalized and taken into account when assessing labor remuneration, these employee parameters increase their mutual control and fosters their integration into a self-regulating system.

Computing device (solution generator) has the following parameters:

I_cm—wages fund (WF) to be distributed by the system;

I_m—wages fund (WF) to be distributed by the manager of the working process;

L_col—the share of collective labor in the working process regulated by the system;

IWI_min—minimal threshold IWI value (involvement index) that triggers re-calculation of input and wages shares of the staff in the work process;

IWI_max—maximal IWI value that triggers re-calculation of input and wages shares of the staff;

ICI—the change index of employee's share of input and wages in work process (damping index);

XIWI—threshold value of test-question (parameter) importance rating, used in selecting test-question to calculate IWI;

XNC—threshold value of problematic parameter rating recommended for next work cycle of the system;

NT—the number of problematic test runs between system configuration.

The system works in the following pattern. Administrator of self-regulating systems, who controls work processes under supervision of self-regulating systems, records staff names into P3 registry (Diagram 4), united by the common work goal (forms a group). In the system registry P1 (Diagram 2), the administrator assesses employees' input into the process, the change range for the unified staff parameters, and the change range of computing device parameters.

Then, using a setup test, the system is configured (frequency of setup and routine testing is set by one of the parameters—NT). For this purpose, each employee fills in their P4 registry (configuration test-card, diagram 5) with their personal (subjective) ratings of the system parameters. Specifically, each employee, writes down parameters' values, which in their opinion other colleagues possess, and parameter' values, which they believe the computing device should have. An operator then enters parameters' values from all configuring registries into structurally identical registries of the computing device, which then conducts the calculations by the operator's command.

During parameter calculation the computing device suppresses interference, averages the ratings, makes necessary adjustments in case the values fall out of the pre-defined range of changes; the resulting values are treated as parameters (carried into the memory). Later, the configured system may be used for several subsequent problematic tests. Every three-five working tests should be followed by one configuration test. This is necessary to complete transitional processes in a group, caused by adjustment of the system parameters and while preserving adequate adaptability of the system through changes of problematic parameters, more frequent than configuration changes.

After the system's parameters have been set, problematic testing takes place. The staff, possibly together with a representative of the computer-assisted management department and a manager of working processes (administrator) enter the descriptions of the problematic parameters (test-questions) into P5 registry (Diagram 6).

Using the data from the registry of problematic parameters' descriptions (P5) and the registry of active elements' (employees') names (P3) (Diagram 4), the staff fill in test-cards (registries of problematic parameters' ratings P6 (Diagram 7)) with their assessments of the parameters' significance (column A) and their evaluation of each employee's activity with regard to these parameters, including results of self-assessment (the rest of the columns). The data from the filled in registries is supplied into the structurally identical registries of the computing device interface. Thereupon, the work of the computing device is managed until the results are output to the feedback registries—P7-P10. Their data is made available for each employee to view. Since each employee is a self-regulated system, with an individual opinion regarding every controllable object or action, the feedback registries directed to them from the computing device are objectively passive. In other words, they may be activated variably (factored in or neglected) by an employee according to their internal disposition (their personal opinion). Optimally, the feedback is treated by a subject as being negative, which assists self-regulation or focused influence on the system or the object of labor according to the divergence between their personal parameter rating (remuneration index, etc.) and the one suggested by the system.

Effectiveness of the system is ensured by self-regulation of each employee according to the system's settings, as well as by self-regulation of the system influenced by each member of staff.

The objective of the system is to generate inside the feedback chain a complex of informational and financial provisions (motivators) for staff productivity.

Optimal (recommended) number of employees in a group controlled by an automated personnel management system—5-8 people, at the maximum of 11.

Performance of the Computing Device—Solution Generator.

Notations:

PA—process administrator

P—pay;

WF—wages fund for a group of employees;

BF—bonus fund;

Sal.—salary;

Inp.—employee's input;

RDA—re-distributable amount (part of an employee's pay);

RDBA—re-distributable bonus amount;

ES—employee's expected salary;

Adm. Res.—administrator's reserves;

CM Res.—system's (cybermanager's) reserves;

TRDA—total re-distributable amount;

IINP.—employee's input into the group's WF;

L_col—share of collective labor;

IWI—employee's index of work involvement;

IE—employee's efficiency index; parameters with “m”—defined by the work process administrator; parameters with “p” subscript—defined by personnel; parameters with “cm” subscript—defined by the computing device;

I—number of employees in a group;

i—employee's serial number in the group;

J—number of self-regulated systems (cybermanagers) controlled by the process administrator;

j—serial number of the work process self-regulating system in the company;

TI—time-sheet index showing the ratio of an employee's factual work time and projected work time in the system-regulated work cycle.

Work Algorithm of the Computing Device.

1. KT NT—projected number of problematic tests between system configuration runs.

2. Problematic test counter zeroing; h—serial number of the test in the cycle between system configuration runs.

3. Problematic test counter

4. Data input from the registry of the source data P1 containing financial settings:

Sal_i; Inp_i; Wages fund amount (WF); Bonus amount; Total input; formula for the index of the decrease of the work involvement index (IDI); ranges of parameters: SC_i, ER_i, ISHARE_i; I_cm, I_m, L_col, IWI_min, IWI_max, ICI, XIWI (IE), XNC; NT Input of the parameters' ratings from P4 (configuration test-cards).

5. Equate the extreme minimal and maximal values of the identically named parameters and indexes/ratings from P4 with the nearest values. Calculate the average values of the parameters and ratings; verify them against the predefined range and correct, if they fall out; assigning parameter status. Input parameters into the computing device.

6. Input data from P2 (time-sheet indexes) and P6 (test-cards of the problematic parameters).

7. Print data (test-card) of the manager's test (P7). Note: Manager's data in the system is more for demo purposes.

8. Check the parity of ER_i In some case for simplicity reasons, the process administrator can make the appropriate decision. In such case the system must be protected from possible destabilizing burst of ratings.

9. Equate the extreme values of the identically named parameters with the nearest values. Other methods to protect the system from destabilizing factors are possible.

10. Calculate grades of the tests of active elements—employees, which were rendered objective (corrected and averaged).

11. Print the resulting grades of the employees' test (P8).

12. Select problematic parameters for the next test and for calculating the index of work involvement, based on the criterion of their overcoming certain thresholds XNC, XIWI (separately by the data from the manager and the subordinate staff).

13. Calculate weight indexes of the problematic parameters, selected for calculating IWI, as a ratio of each importance index of each prepared test-question (column A) to the total of the indexes for all prepared test-questions. Re-calculate the indexes into a score, by multiplying the weight indexes of the problematic parameters and employees' expert ratings.

14. Calculate employees' inputs (expected remuneration), re-distributable by the system. Reserve the rest of the inputs.

RDSI_i=Inp_i*I_cm-employees' inputs re-distributed by the cybermanager;

Iinp=Inp_i/total Inp_i

RDBA_i=BF*Iinp_i-redistributable bonus amount (BF—bonus fund)

RDA_i=(Inp_i*I_cm+BF*Iinp_i)-re-distributable amount of employee's remuneration (the bonus is fully redistributed)

15. Calculate re-distributable amounts, pertaining to the collective labor:

RDA_col_i=RDA_i*L_col-redistributed amount pertaining to the collective input;

16. Calculate the total amount of redistributable amounts (combined pool):

TRDA=total RDA_col_i

17. Calculate the expected collective constituent in the employee's pay.

ES_i_col=TRDA*ISHARE_i*TI_i, where TI—time-sheet index.

18. Calculate the index of decreasing employees' IWI (IDI_i).

Calculate IWI_i_p (from a group of subordinates) and factor in IDI_i (based on the data of the test of the subordinates); calculate IWI_i_m (based on the data of the manager test) and factor in IDI_i.

19. Calculate the component of the employees' pay, corresponding to the collective labor, from the manager and the subordinates.

P_i_gr_col=P_i_col*(1−I_m)*IWI_i_p

P_i_m_col=P_i_col*I_m*IWI_i_m

20. Calculate re-distributable money amounts of the subjects, reflecting individual work efficiency:

P_i_ind=RDA_i*(1-L_col)*TI_i

21. Calculate the effectiveness indexes of the employees. This is done in cases, when there are special test-questions to determine work effectiveness. Otherwise, IWI=IE. Calculate IE_i_p and factor in IDI_i (based on the data of the test of the subordinates); calculate IE_i_m (based on the data of the manager test) and factor in IDI_i.

22. Calculate the component of the employees' pay, corresponding to the individual work, from the manager and the subordinates.

P_i_p_ind=P_i_ind*(1−I_m)*IWI_i_p

P_i_m_ind=P_i_ind*I_m*IWI_i_m

23. Calculate P_i_J (employee # i in work process # J)

P_i=P_i_p_col+P_i_m_col+P_i_gr_ind+P_i_m_ind+Res.P_i_adm+Res.P_i_cm

24. Form the data for P9.

The work cycle of the automated personnel management system ends. Before the next problematic testing, certain processes will take place for some employees to adjust to the solutions generated by the system.

Block19 ( [symbol] . 10)—calculation algorithm for IWI (IE).

IWI_i-IWI decreasing index of employee # i. First, the test-card data of the subordinate staff is processed. The manager's test-card is processed separately, following the similar algorithm.

1. Among the IWI_i_p of the problematic parameters (test-questions) selected for calculation (IE_i_p-effectiveness index of the employee # i, defined by the subordinate staff) the analysis encompasses the ratings in all identically named cells in the test-cards of the subordinate staff. The minimal and maximal rating values contained in the cells are equated to the nearest values.

2. The average values of the identically named cells in all test cards are calculated.

3. Test-questions with ratings in column A being greater or equal to the threshold value XIWI (XIE) are picked for further calculations.

4. Weight indexes of the test-questions are calculated based on the resulting values in the cells of column A (the ratio of a question's rating to the sum of the ratings used in the calculation)

5. The rating values in the cells (apart from column A) are multiplied by the corresponding weight indexes and employees' expert ratings.

6. The rating values in the cells (apart from column A) are added by the columns. The totals in the columns are the score accumulated by each employee by the problematic parameters selected for calculations.

7. The totals in the columns are added. The result is the total score accumulated by all employees in this test for selected test-questions.

8. The ratio of the columns' sums to the total is calculated, which are the preliminary values of IWI_i_p (IWI of the subordinate staff, including the manager, defined by the subordinates)

9. IWI decreasing indexes are calculated and re-calculation of the latter takes place. Recommended formula IDI=1−(1−SC)²,

Calculations of IWI_i_m are done in the same manner, the only difference being they are based on the data of the single test-card of the manager. Also, neither interference suppression, nor averaging occur. In all other respects the algorithm is the same as the one used to calculate IWI from a group of employees.

The manager and the group are provided with independent wages funds, defined by parameters I_cm, I_m (obviously: I_gr=I_cm−I_m) and distributed according to the calculated KTy IWI and IE of the staff.

The problematic questions of the tests may be universal, encompassing the collective and individual constituents of the work. Accordingly, both branches can use equal IWI and IE. The problematic questions to determine IWI and IE are absolutely identical in this algorithm, IWI_i=IE_i.

1. Self-regulating system of personnel management incorporating a computing device, data input and output devices, registries; the main difference of the system is the presence the active elements.

2. Self-regulating system as in 1, the difference being that outputs of the active elements are connected with a data input device; in turn, the outputs of the input device are connected with the registries of the computing device: registry of the source data, registry of table indexes, registry of active elements' names, registry of the assessments of the computing device's parameters and of unified parameters of the active elements, registry of problematic parameters' ratings; the outputs of the computing device's registries—registry of the assessments of the administrative active element, registry of the assessments by the active elements, registry of the current status of the self-regulating system, registry of the problematic parameters recommended by the self-regulating system—are connected to a data output device; the data output device is connected with the active elements and the administrator of the self-regulating system.

3. Self-regulating system as in 1, the difference being that active elements are represented by personnel.

4. Self-regulating system as in 1, the difference being in three groups of characteristic parameters: unified parameters of the active elements realized as employee's controllability, employees expertise rating, his/her share of input and remuneration; parameters of the computing device, and current problematic parameters.

5. Self-regulating system as in 4, the difference being that the computing device uses the following as its parameters: a part of the wages fund designated for redistribution by the self-regulating system, a part of the wages fund designated for redistribution by the administrative active element, a part of the collective input into the work process, the minimal threshold value of the work input index that triggers the algorithm of redistribution of the employees' input and pay; the maximal threshold value of the work input index that triggers the algorithm of redistribution of the employees' input and pay; index of the change in employee's input and remuneration in a work process; threshold value of the test-questions' importance rating used to select test-questions to calculate en employee's input; threshold value of the problematic parameters' ratings used to select problematic parameters recommended for the next work cycle of the self-regulating system; indicator of the number of tests on the problematic parameters in between the configuration runs of the self-regulating system.

6. Self-regulating system as in 1, the difference being that the registry of the assessments of the computing device's parameters and of unified parameters of the active elements, registry of problematic parameters' ratings are implemented as test-cards.
